(19) United States
(12) Patent Application Publication
(10) Pub. No.: US 2016/0157199 A1
(43) Pub. Date: Jun. 2, 2016

(54) COMMUNICATION DEVICE AND COMMUNICATION METHOD IN RADIO COMMUNICATION SYSTEM

(71) Applicant: FUJITSU LIMITED, Kawasaki-shi (JP)

(72) Inventors: Hiroaki Senoo, Kawasaki (JP); Hideto Furukawa, Yokohama (JP)

(73) Assignee: FUJITSU LIMITED, Kawasaki-shi (JP)

(21) Appl. No.: 15/003,218

(22) Filed: Jan. 21, 2016

Related U.S. Application Data
(63) Continuation of application No. PCT/JP2013/071985, filed on Aug. 15, 2013.

(51) Int. Cl. H04W 56/00; H04W 72/08; H04L 5/00

(52) U.S. Cl. CPC H04W 56/0055; H04L 5/0048; H04W 56/0005; H04W 72/085

(57) ABSTRACT

The communication device of a carrier aggregation system includes a propagation delay amount estimation unit and a network-side interface. The propagation delay amount estimation unit receives from the first base station a terminal list of user equipment that exists within a coverage area range of the second base station and to which a cell that is uplink-synchronized with the primary cell is allocated, and information of an uplink pilot signal in the primary cell. With respect to the terminal list, the propagation delay amount estimation unit sniffs the uplink pilot signal that is transmitted to the first base station. According to the uplink pilot signal in the primary cell and a reception timing that the communication device itself which configures the second base station retains, the propagation delay amount estimation unit estimates a propagation delay amount between the primary cell and the secondary cell and an uplink-timing correction amount.

### CROSS-REFERENCE TO RELATED APPLICATION

This application is a continuation application of International Application PCT/JP2013/071985 filed on Aug. 15, 2013 and designated the U.S., the entire contents of which are incorporated herein by reference.

### FIELD

The embodiments discussed herein are related to a communication device and a communication method in a radio communication system.

### BACKGROUND

In the 3rd Generation Partnership Project (3GPP), standardization of the fourth-generation (4G) mobile telecommunication system, which is an enhancement of Long Term Evolution (LTE), is being promoted as a next-generation mobile communication system in order to achieve high-speed and large-capacity communication. An example of the fourth-generation (4G) mobile telecommunication system is LTE-advanced (LTE-A).

In LTE-advanced, a carrier aggregation technology is introduced which aggregates a plurality of carriers that have different frequency ranges in order to achieve a wider bandwidth as well as to ensure compatibility with LTE. In the carrier aggregation technology, each aggregated carrier is referred to as a component carrier.

The component carrier that is used in communication which uses the carrier aggregation technology is allocated as the component carrier which is unique to a terminal by a base station upon starting or reconfiguring of carrier aggregation communication. A cell which mediates communication is configured by including one primary cell (hereinafter referred to as a PCell) and one or more secondary cells (hereinafter referred to as an SCell).

The PCell mainly communicates control information and data information. A component carrier (CC) that corresponds to the PCell is referred to as a primary component carrier (PCC). The SCell mainly communicates data information. A component carrier that corresponds to the SCell is referred to as a secondary component carrier (SCC).

The SCC is in either a configured state or a non-configured state. Furthermore, the configured state includes an activated state and a deactivated state. In the deactivated state, data communication is disabled. When carrier aggregation is performed, an SCell is added, and the configured state of the SCC that corresponds to the SCell which has just been added is the deactivated state. The base station judges the communication quality of the deactivated SCell according to information from user equipment (also referred to as UE, mobile terminal, and mobile station). When the base station judges that it is preferable to communicate with the SCell, the base station changes the configured state of the SCell into the activated state and causes the SCell to start communication with the mobile station.

In order to deal with increasing traffic, a heterogeneous network (HetNet) is known in which an area is formed by abase station of a small cell size (small cell) within an area (macrocell) of a large cell size in order to increase the entire capacity. In the heterogeneous network (HetNet), a network is configured by combining different elements. In general, picocells and femtocells are hierarchically arranged so as to overlap the macrocell that is covered by a normal base station and to cover limited ranges. In addition, the HetNet allows use of a heterogeneous network such as a radio local area network (LAN) and makes possible optimization of the traffic balance of the entire network.

In addition, in 3GPP, standardization of Evolved Universal Terrestrial Radio Access (EUTRA) is being promoted. Orthogonal Frequency Division Multiplexing (OFDM) that is resistant to multipath interference and is suitable for high-speed transmission has been adopted as the downlink communication scheme of EUTRA. A single-carrier frequency-division multiple access scheme (SC-FDMA) that can reduce the peak-to-average power ratio (PAPR) of a transmission signal has been adopted as the uplink communication scheme of EUTRA.

In Advanced-EUTRA, which is an advanced version of EUTRA, a bandwidth of up to 100 megahertz is planned to be achieved by aggregating a plurality of bandwidths lower than or equal to the 20 megahertz of EUTRA. In Advanced-EUTRA, a frequency carrier that has a bandwidth lower than or equal to the 20 megahertz of EUTRA is referred to as a component carrier and a cell is configured by combining a downlink component carrier and an uplink component carrier. A base station allocates a plurality of cells to a user terminal and communicates with user equipment via the allocated cells.
Non-patent document 1: 3GPP Technical Specification TS 36.300 V10.6.0 “7.5 Carrier Aggregation”

### SUMMARY

A communication device is provided which configures a second base station of a carrier aggregation system that includes a first base station to which a primary cell is allocated and the second base station to which a secondary cell is allocated. The communication device includes a propagation delay amount estimation unit and a network-side interface. The propagation delay amount estimation unit receives from the first base station a terminal list, which is a list of pieces of user equipment that exist within a coverage area range of the second base station and to which a cell that is uplink-synchronized with the primary cell is allocated, and information of an uplink pilot signal in the primary cell. With respect to one of the plurality of pieces of user equipment that is included in the terminal list, the propagation delay amount estimation unit sniffs the uplink pilot signal that is transmitted to the first base station. According to the uplink pilot signal in the primary cell and a reception timing that the communication device itself which configures the second base station retains, the propagation delay amount estimation unit estimates a propagation delay amount between the primary cell and the secondary cell and an uplink-timing correction amount, which is a correction amount of a transmission timing to be corrected in order to make the plurality of pieces of user equipment synchronous with the second base station. The network-side interface transmits to the first base station the propagation delay amount and the uplink-timing correction amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an outline of a carrier aggregation system.

FIG. 2 is a diagram explaining carrier aggregation.

FIG. 3 is a diagram explaining uplink carrier aggregation under a heterogeneous network environment.

FIG. 4 is a diagram illustrating an example of a functional block diagram of a communication device of a base station.

FIG. 5 is a diagram illustrating a flow of an uplink-timing synchronization process of a secondary cell (SCell) in a comparative example.

FIG. 6 is a diagram illustrating an example of a functional block diagram of a communication device of a base station in an example.

FIG. 7 is a diagram illustrating a flow of estimation of a propagation delay amount in the SCell.

FIG. 8 is a diagram illustrating an example of a format that is used for notification of an uplink-synchronized terminal list and uplink pilot signal allocation information.

FIG. 9 is a diagram illustrating an example of a format that is used for notification of a propagation delay amount.

FIG. 10 is a diagram illustrating an example of a hardware configuration of the communication device of the base station.

FIG. 11 is a diagram illustrating a flow of an uplink-timing synchronization process of the SCell in the example.

FIG. 12 is a flowchart illustrating an example of a process flow in a process for generating a list of terminals that are synchronized with a primary cell (PCell).

FIG. 13 is a flowchart illustrating an example of a process flow in a process for estimating a propagation delay amount between the PCell and the SCell.

### DESCRIPTION OF EMBODIMENTS

Under an environment in which a primary cell (PCell) and a secondary cell (SCell) use different frequency bandwidths, the coverage area of the SCell overlaps the coverage area of the PCell, and the PCell and the SCell are timing-synchronized with each other, in a case in which a piece of user equipment UE#A is uplink-synchronized with a macro base station, another piece of user equipment UE#B is uplink-synchronized with the SCell and the user equipment UE#A performs uplink carrier aggregation between the PCell and the SCell, the uplink reception timing may differ between the user equipment UE#A and the user equipment UE#3 at the reception point of the SCell. Thus, there is a problem in which uplink intersymbol interference from the user equipment UE#A and UE#B is generated at the reception point of the SCell and uplink throughput deteriorates.

Therefore, in an aspect, the object of the embodiments is to provide a communication device and a communication method in a radio communication system that suppresses generation of uplink intersymbol interference from the user equipment UE#A and UE#B by correcting a transmission timing of the user equipment so that a difference in uplink reception timing between the user equipment UE#A and UE#B is not generated at the reception point of the SCell after the configured state of the secondary cell (SCell) is changed into the activated state, and improves uplink throughput.

With reference to the drawings, first, uplink-timing synchronization of the secondary cell (SCell) in a carrier aggregation system will be described.

### <Uplink-Timing Synchronization of Secondary Cell>

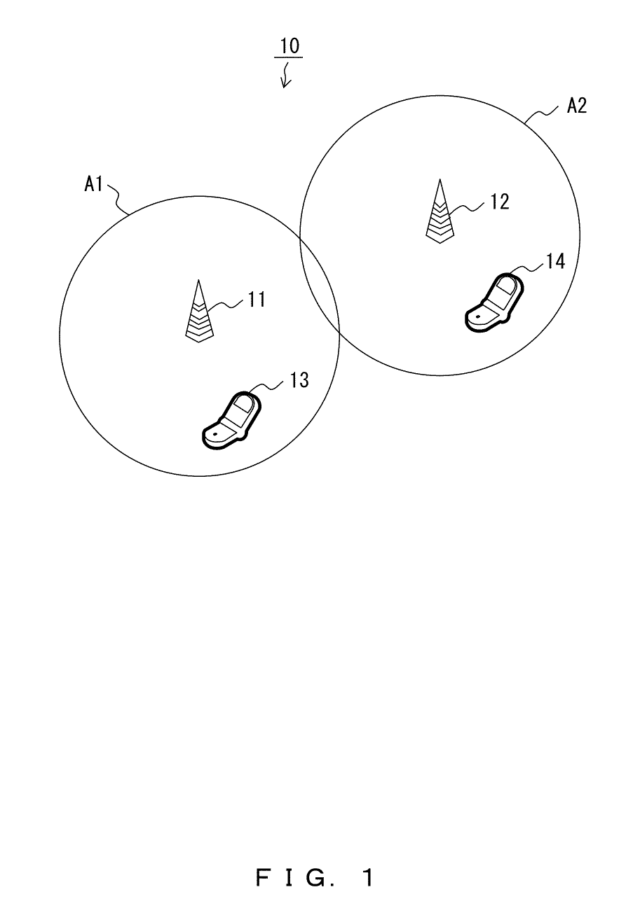

FIG. 1 is a diagram illustrating an outline of a radio communication system, in particular, a carrier aggregation system.

The following radio communication system 10 is configured according to Long Term Evolution (LTE)-Advanced (after 3rd Generation Partnership Project (3GPP) release 10).

As illustrated in FIG. 1, the radio communication system 10 is configured as an Evolved-Universal Mobile Telecommunications System Terrestrial Radio Access Network (E-UTRAN), which is a radio access network. Furthermore, the E-UTRAN 10 is configured as a heterogeneous network (HetNet) and includes various types of base stations that have different service area ranges. Base stations (eNB) 11 and 12 form cells A1 and A2, which are connectable areas of the base stations, respectively. The base stations and the user equipment (also referred to as UE or mobile stations) 13 and 14 communicate with each other via a radio interface. For example, in FIG. 1, the base station (evolutional Node B, eNB) 11 that is compatible with LTE covers the cell A1 as a service area range, and the base station 11 communicates with the user equipment 13 that exists in the cell A1. In addition, the base station 12 covers the cell A2 as a service area range and the base station 12 communicates with the user equipment 14 that exists in the cell A2.

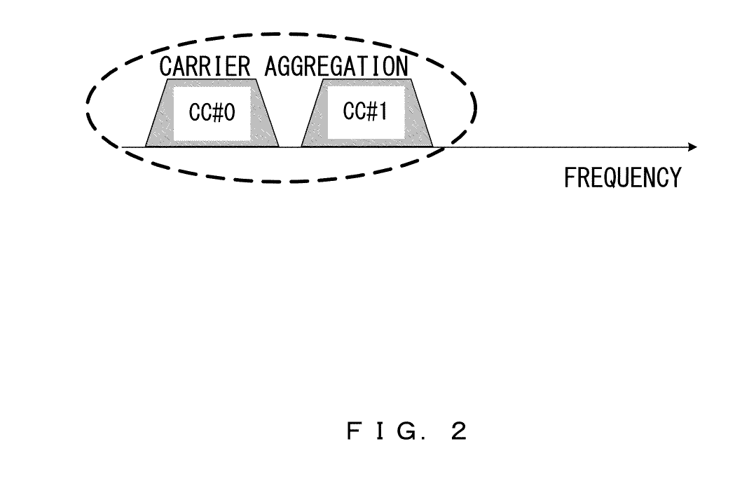

FIG. 2 is a diagram explaining the carrier aggregation.

In LTE-advanced, a carrier aggregation (CA) technology is introduced which aggregates a plurality of carriers that belongs to a plurality of frequency bandwidths in order to achieve a wider bandwidth. Each aggregated carrier is referred to as a component carrier (CC). In the carrier aggregation technology, it is possible to increase the number of contained users and to increase the maximum throughput by aggregating a plurality of component carriers and simultaneously using a plurality of frequency bandwidths.

In addition, in 3GPP, standardization of Evolved Universal Terrestrial Radio Access (EUTRA) is being promoted. Orthogonal Frequency Division Multiplexing (OFDM) that is resistant to multipath interference and is suitable for high-speed transmission has been adopted as the downlink communication scheme of EUTRA. A single-carrier frequency-division multiple access scheme (SC-FDMA) that can reduce the peak-to-average power ratio (PAPR) of a transmission signal has been adopted as an uplink communication scheme.

In Advanced-EUTRA, which is an advanced version of EUTRA, it is planned to achieve a bandwidth of up to 100 megahertz by aggregating a plurality of bandwidths lower than or equal to the 20 megahertz of EUTRA. In Advanced-EUTRA, a frequency carrier that has a bandwidth lower than or equal to the 20 megahertz of EUTRA is referred to as a component carrier and a cell is configured by combining a downlink component carrier and an uplink component carrier. A base station allocates a plurality of cells to a user terminal and communicates with user equipment via the allocated cells.

The component carrier that is used in communication which uses the carrier aggregation technology is allocated as the component carrier which is unique to a terminal from the base station upon starting or reconfiguring of carrier aggregation communication. A cell which performs communication is configured by including a primary cell (hereinafter referred to as a PCell) and one or more secondary cells (hereinafter referred to as an SCell). Communication from the user equipment to the SCell or communication from the SCell to the user equipment may be started or stopped by setting the configured state of the SCell to an activated state or a deactivated state.

In addition, in order to reduce power consumption of the user equipment, the user equipment does not perform a downlink reception process with respect to the SCell which has just been allocated. After the base station instructs the SCell to be activated, the user equipment initiates the downlink reception process with respect to the SCell which has been instructed to be activated. In addition, after the base station instructs the activated SCell to be deactivated, the user equipment stops the downlink reception process with respect to the SCell which has been instructed to be deactivated. The SCell which is instructed by the base station to be activated and for which the downlink reception process is performed is referred to as an activated cell. The SCell which has just been allocated to the user equipment by the base station or the SCell that is instructed to be deactivated and for which the downlink reception process is stopped is referred to as a deactivated cell. The PCell is an activated cell.

FIG. 2 illustrates a state in which two component carriers CC#0 and CC#1 that have different frequency bandwidths are aggregated. In FIG. 2, the component carrier CC#0 corresponds to the PCell and the component carrier CC#1 corresponds to the SCell.

In FIG. 2, the number of component carriers is 2; however, the number of component carriers is not limited to 2. In addition, in FIG. 2, the component carriers CC#0 and CC#1 are adjacent to each other; however, a gap may exist therebetween. Furthermore, for example, the component carriers CC#0 and CC#1 may belong to an 800 megahertz band and a 1.5 gigahertz band, respectively. In addition, component carriers may be adjacent to each other in the frequency domain.

Each component carrier corresponds to one carrier (frequency band) of LTE.

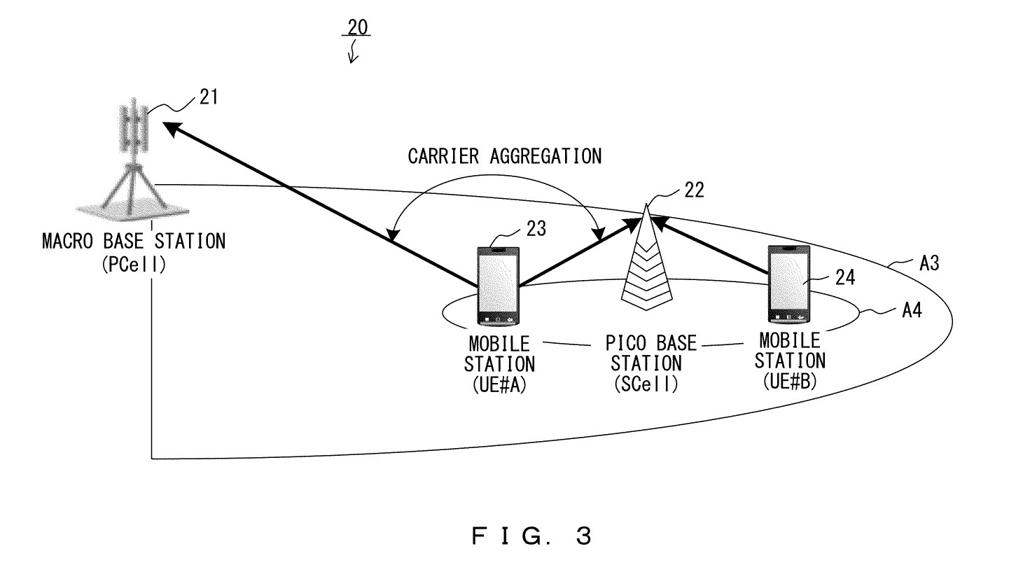

FIG. 3 is a diagram explaining uplink carrier aggregation under a HetNet environment. In a heterogeneous network (HetNet), not only a high-power base station (also referred to as a macro base station) but also a low-power base station (pico base station) that has a small service area range are arranged. In FIG. 3, one pico base station 22 is arranged within the service area range of a macro base station 21; however, the number of pico base stations that are arranged within the service area range of the macro base station 21 is not limited to 1 and may be 2 or greater.

In the radio communication system illustrated in FIG. 3, the service area range of the macro base station 21 is an area A3 and the PCell is allocated to the macro base station 21. The service area range of the pico base station 22 is an area A4 and the SCell is allocated to the pico base station 22. Even though the macro base station 21 (PCell) and the pico base station 22 (SCell) use different frequency bandwidths, downlink timing synchronization is established between them. The area A4 is a portion of the area A3. User equipment 23 (UE#A) and user equipment 24 (UE#B) exist in the area A4. The user equipment 23 (UE#A) is uplink-synchronized with the macro base station 21 (PCell) and the user equipment 24 (UE#B) is uplink-synchronized with the pico base station 22 (SCell). That is, the user equipment 23 (UE#A) transmits a signal to the macro base station 21 (PCell) at an adjusted uplink (UL) timing. The user equipment 24 (UE#B) transmits a signal to the pico base station 22 (SCell) at an adjusted uplink (UL) timing.

In FIG. 3, the one user equipment 23 (UE#A) and the one user equipment 24 (UE#B) are connected to each of the macro base station 21 (PCell) and the pico base station 22 (SCell); however, more pieces of user equipment may be connected. User equipment that supports the carrier aggregation technology may aggregate a plurality of component carriers and use them for communication. That is, the user equipment that supports the carrier aggregation technology may simultaneously communicate with a plurality of cells, the PCell and/or the SCell.

In a case in which the user equipment 23 (UE#A) performs uplink CA between the macro base station 21 (PCell) and the pico base station 22 (SCell), the uplink reception timing may differ between the user equipment 23 (UE#A) and the user equipment 24 (UE#B) at the reception point of the pico base station 22 (SCell). Then, interference is generated between a signal from the user equipment 23 (UE#A) and a signal from the user equipment 24 (UE#B) at the reception point of the pico base station 22 (SCell).

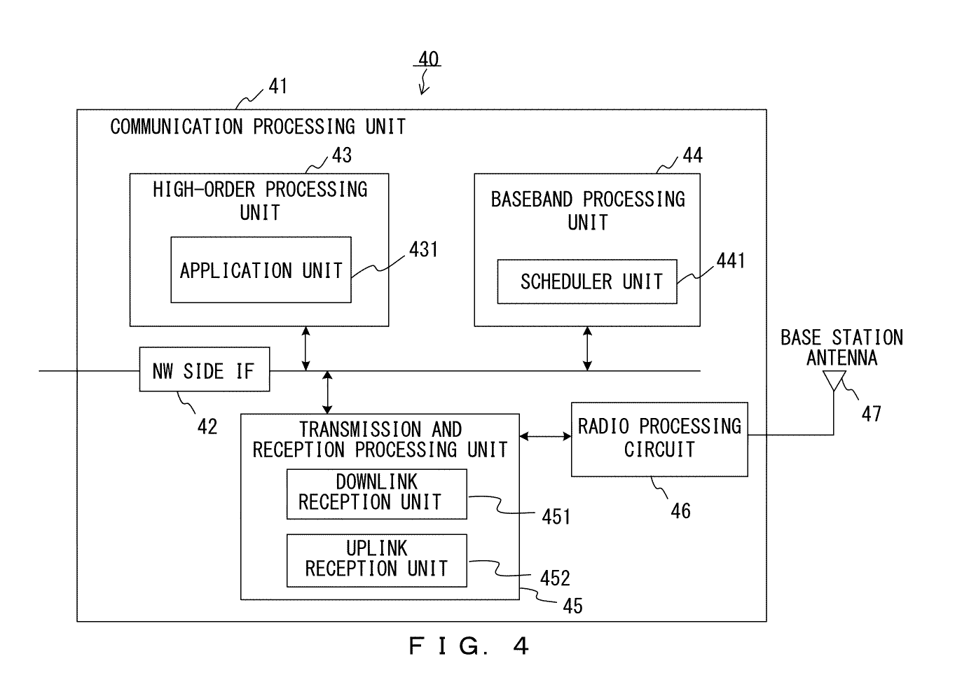

FIG. 4 is a diagram illustrating an example of a functional block diagram of a communication device 40 of a base station. The communication device 40 of the base station includes a communication processing unit 41 and an antenna 47 for the base station. Furthermore, the communication processing unit 41 includes a network-side interface (NW side IF) 42, a high-layer processing unit 43, a baseband processing unit 44, a transmission and reception processing unit 45, and a radio processing circuit 46.

The antenna 47 for the base station emits a radio signal to a mobile station such as the user equipment 23 (UE#A) and the user equipment 24 (UE#B) and receives a radio signal from the mobile station.

The radio processing circuit 46 converts a baseband frequency into a radio frequency, and vice versa.

The transmission and reception processing unit 45 performs a layer-1 process. The transmission and reception processing unit 45 includes a downlink transmission unit (DL transmission unit) 451 and an uplink reception unit (UL reception unit) 452. The downlink transmission unit (DL transmission unit) 451 performs a transmission process for the mobile station such as the user equipment 23 (UE#A) and the user equipment 24 (UE#B). The uplink reception unit (UL reception unit) 452 receives a signal from the mobile station and decodes the signal.

The baseband processing unit 44 includes a scheduler unit 441. The baseband processing unit 44 manages the control of layer 1 and layer 2.

The high-layer processing unit 43 includes the application unit 431. The high-layer processing unit 43 performs high-layer processes such as a layer-2 process, radio resource management, and inter-base-station signal transmission and reception process. The application unit 431 performs processing of an application.

The network-side interface (NW side IF) 42 performs high-layer processes such as signal transmission and reception between itself and an NW side device.

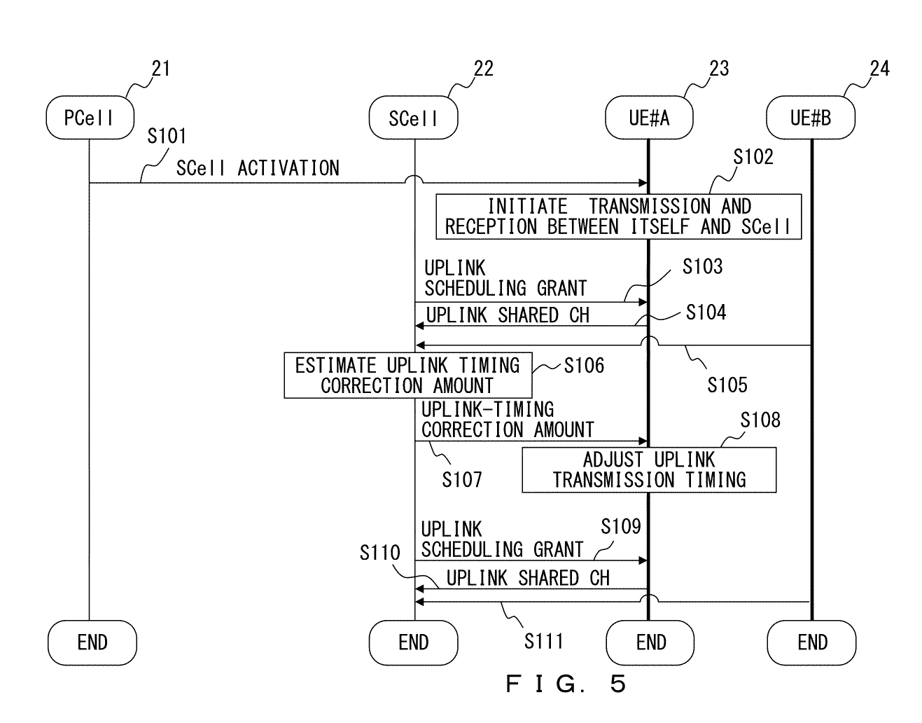

FIG. 5 is a diagram illustrating a flow of an uplink-timing synchronization process of the secondary cell (SCell) in a comparative example.

FIG. 5 illustrates a flow of the process that is performed when the SCell is activated in a carrier aggregation system 20 that includes the macro base station 21 (PCell), the pico base station 22 (SCell), the user equipment 23 (UE#A), and the user equipment 24 (UE#B). Before the process is initiated, the configured state of the pico base station 22 (SCell) is the deactivated state. In addition, it is assumed that the user equipment 23 (UE#A) is uplink-synchronized with the macro base station 21 (PCell). Furthermore, it is assumed that the user equipment 24 (UE#B) is uplink-synchronized with the pico base station 22 (SCell).

In S101, the user equipment 23 (UE#A) receives a signal that includes an activation instruction from the macro base station 21 (PCell).

In S102, the user equipment 23 (UE#A) initiates transmission and reception between itself and the pico base station 22 (SCell).

In S103, the pico base station 22 (SCell) gives to the user equipment 23 (UE#A) a notification for uplink scheduling grant. For example, the pico base station 22 (SCell) notifies the user equipment 23 (UE#A) of radio resource information, a modulation scheme, a code rate, etc. that are used in an uplink shared channel (CH).

In S104, the user equipment 23 (UE#A) notifies the pico base station 22 (SCell) of the uplink shared channel (CH).

Almost simultaneously with S104, in S105, the user equipment 24 (UE#B) notifies the pico base station 22 (SCell) of the uplink shared channel (CH).

Then, a signal from the user equipment 23 (UE#A) and a signal from the user equipment 24 (UE#B) interfere with each other at the reception point of the pico base station 22 (SCell).

In S106, the pico base station 22 (SCell) estimates an uplink-timing correction amount.

In S107, the pico base station 22 (SCell) notifies the user equipment 23 (UE#A) of the uplink-timing correction amount that has been estimated in S106.

In S108, the user equipment 23 (UE#A) adjusts an uplink transmission timing. When the process in this step is terminated, the user equipment 23 (UE#A) becomes synchronized with the pico base station 22 (SCell).

In S109, the pico base station 22 (SCell) gives to the user equipment 23 (UE#A) a notification for uplink scheduling grant.

In S110, the user equipment 23 (UE#A) notifies the pico base station 22 (SCell) of the uplink shared channel (CH).

Almost simultaneously with S110, in S111, the user equipment (UE#B) notifies the pico base station 22 (SCell) of the uplink shared channel (CH).

At that time, a signal from the user equipment 23 (UE#A) and a signal from the user equipment 24 (UE#B) do not interfere with each other at the reception point of the pico base station 22 (SCell).

As described, in a case in which the user equipment 23 (UE#A) performs uplink carrier aggregation between the pico base station 22 (SCell) and the macro base station 21 (PCell), the uplink reception timing may differ between the user equipment 23 (UE#A) and the user equipment 24 (UE#B) at the reception point of the pico base station (SCell). Thus, there is a problem in which uplink intersymbol interference is generated and throughput deteriorates.

Therefore, the communication device and the communication method that will be described below perform the following process in order to eliminate a difference in uplink reception timing between the user equipment 23 (UE#A) and the user equipment 24 (UE#B) at the reception point of the pico base station (SCell) and to eliminate intersymbol interference.

(S1) Prior to activation of the pico base station 22 (SCell), the macro base station 21 (PCell) generates a list of terminals that exist in the vicinity of the pico base station 22 (SCell) and are uplink-synchronized with the macro base station 21 (PCell).
(S2) The macro base station 21 (PCell) transmits to the pico base station 22 (SCell) the uplink-synchronized terminal list and uplink pilot signal allocation information in the macro base station 21 (PCell).
(S3) The pico base station 22 (SCell) that has received the uplink pilot signal allocation information sniffs (receives by means of interception) the uplink pilot signal that is transmitted to the macro base station 21 (PCell) with respect to a terminal on the uplink-synchronized terminal list, estimates a propagation delay amount between the macro base station 21 (PCell) and the pico base station 22 (SCell), and transmits the propagation delay amount to the macro base station 21 (PCell).
(S4) The macro base station 21 (PCell) transmits to the terminal an uplink-timing correction amount based on the result of propagation delay amount estimation simultaneously with activation of the pico base station 22 (SCell).

By performing the above (S1) to (S4), a transmission timing of the user equipment is corrected so that a difference in uplink reception timing between the user equipment UE#A and UE#B is not generated at the reception point of the SCell. Therefore, it is possible to suppress generation of uplink intersymbol interference from the user equipment UE#A and UE#B and to improve uplink throughput.

### <Communication Device>

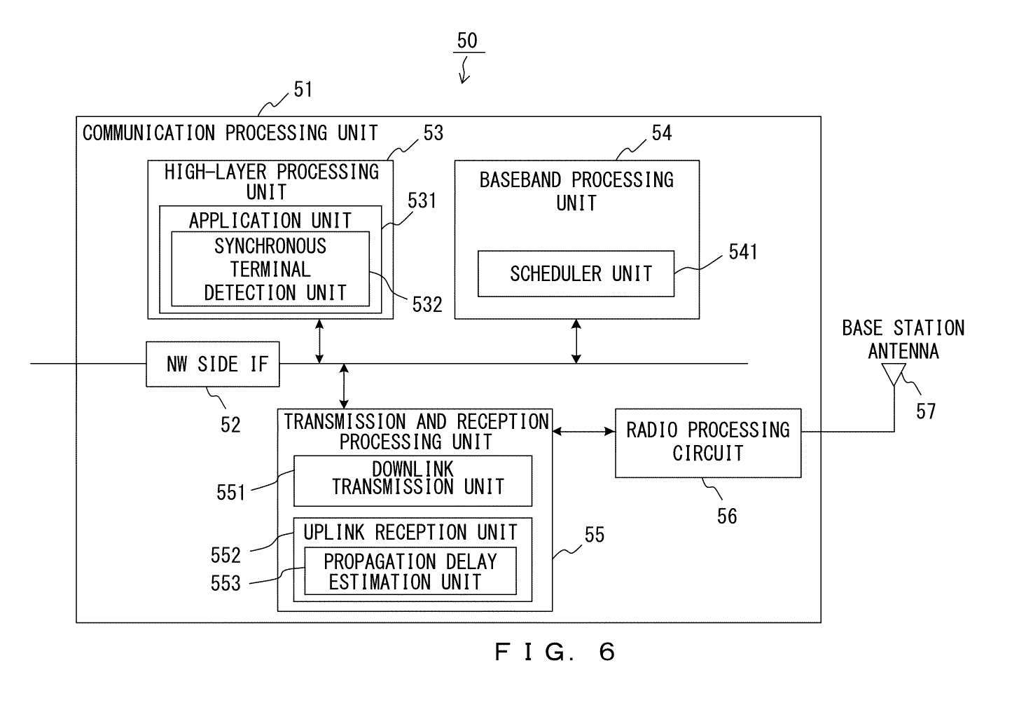

FIG. 6 is a diagram illustrating an example of the functional block diagram of a communication device 50 of a base station in an example.

Similarly to the communication device 40 of the base station, the communication device 50 includes a communication processing unit and an antenna 57 for the base station. Furthermore, the communication processing unit 51 includes a network-side interface (NW side IF) 52, a high-layer processing unit 53, a baseband processing unit 54, a transmission and reception processing unit 55, and a radio processing circuit 56.

The antenna 57 for the base station emits a radio signal to the mobile station such as the user equipment 23 (UE#A) and the user equipment 24 (UE#B) and receives a radio signal from the mobile station.

The radio processing circuit 56 converts a baseband frequency into a radio frequency, and vice versa.

The transmission and reception processing unit 55 performs a layer-1 process. The transmission and reception processing unit 55 includes a downlink transmission unit (DL transmission unit) 551 and an uplink reception unit (UL reception unit) 552.

The downlink transmission unit (DL transmission unit) 551 performs a transmission process for the mobile station such as the user equipment 23 (UE#A) and the user equipment 24 (UE#B). For example, in a case in which the communication device 50 is the macro base station 21 (PCell), the downlink transmission unit (DL transmission unit) 551 transmits to the pico base station 22 (SCell) an uplink-synchronized terminal list and uplink pilot signal allocation information in the macro base station 21 (PCell).

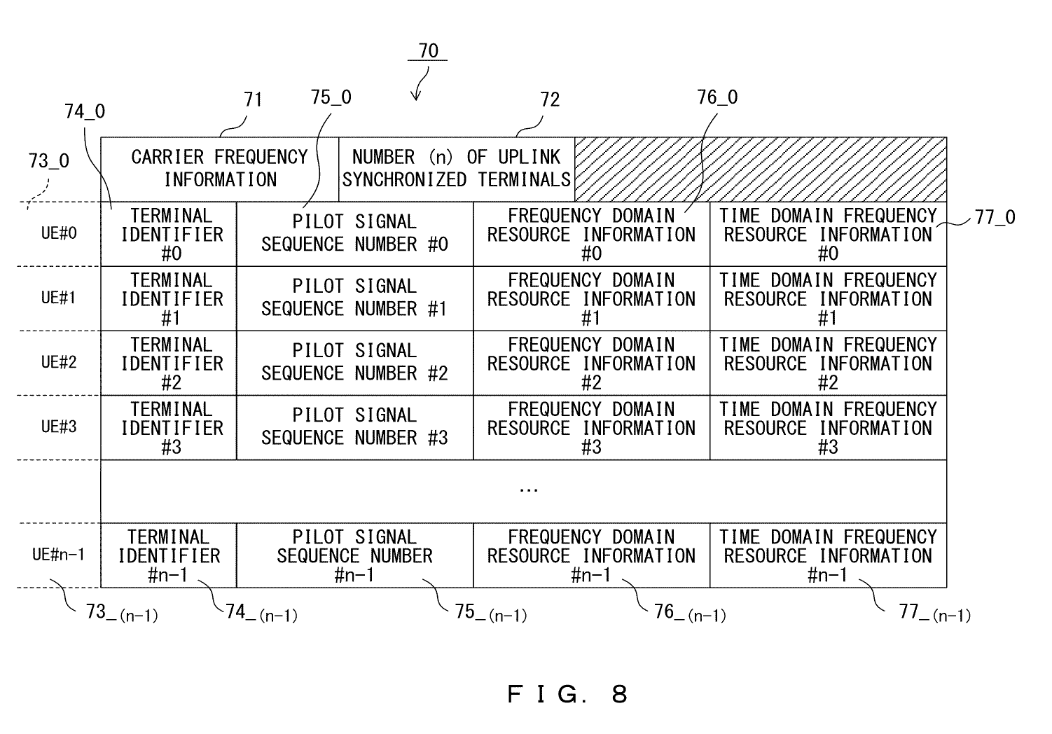

FIG. 8 is a diagram illustrating an example of a format 70 that is used for notification of an uplink-synchronized terminal list and uplink pilot signal allocation information.

The format 70 is an example of the format that is used in a case of transmitting and receiving the uplink-synchronized terminal list and the uplink pilot signal allocation information in one format.

The first line of the format 70 includes a “carrier frequency information” field 71 and a “number of uplink-synchronized terminals” field 72. In the “carrier frequency information” field 71, for example, the carrier frequency of the macro base station 21 (PCell) is stored. Carrier frequency information is used for sniffing a signal to the macro base station 21 (PCell) in the pico base station 22 (SCell). In the “number of uplink-synchronized terminals” field 72, the number n of terminals that will be entered on a subsequent list may be stored.

The second and subsequent lines of the format 70 include “device name” fields 73₀-73ₙ₋₁, “terminal identifier” fields 74₀-74ₙ₋₁, “pilot signal sequence number” fields 75₀-75ₙ₋₁, “frequency domain resource information” fields 76₀-76ₙ₋₁, and “time domain frequency resource information” fields 77₀-77ₙ₋₁.

As a terminal identifier, an identifier (ID) that can uniquely identify a terminal is stored. The terminal identifier may be a Cell-Radio Network Temporary Identifier (C-RNTI).

The pilot signal sequence number is information that is used for creating a replica of a pilot signal. The pilot signal sequence number may include, for example, the sequence number, a cyclic shift amount, and a transmission comb number of the pilot signal.

Frequency domain resource information indicates a frequency resource that is used when the terminal transmits a pilot signal. The frequency domain resource information may include, for example, a start resource block number and the number of used resource blocks.

Time domain frequency resource information indicates information of a timing at which the pilot signal is transmitted. The time domain frequency resource information may include, for example, a subframe period and a subframe offset number.

In addition, in a case in which the communication device 50 is the pico base station 22 (SCell), the uplink reception unit (UL reception unit) 552 includes a propagation delay estimation unit 553. The uplink reception unit (UL reception unit) 552 receives and decodes a signal from the mobile station.

In addition, in the case in which the communication device 50 is the pico base station 22 (SCell), according to uplink pilot signal allocation information that has been transmitted from the macro base station 21 (PCell), the propagation delay estimation unit 553 sniffs (receives by means of interception) an uplink pilot signal that is transmitted to the macro base station 21 (PCell) with respect to a terminal on the uplink-synchronized terminal list, and estimates a propagation delay amount between the macro base station 21 (PCell) and the pico base station 22 (SCell).

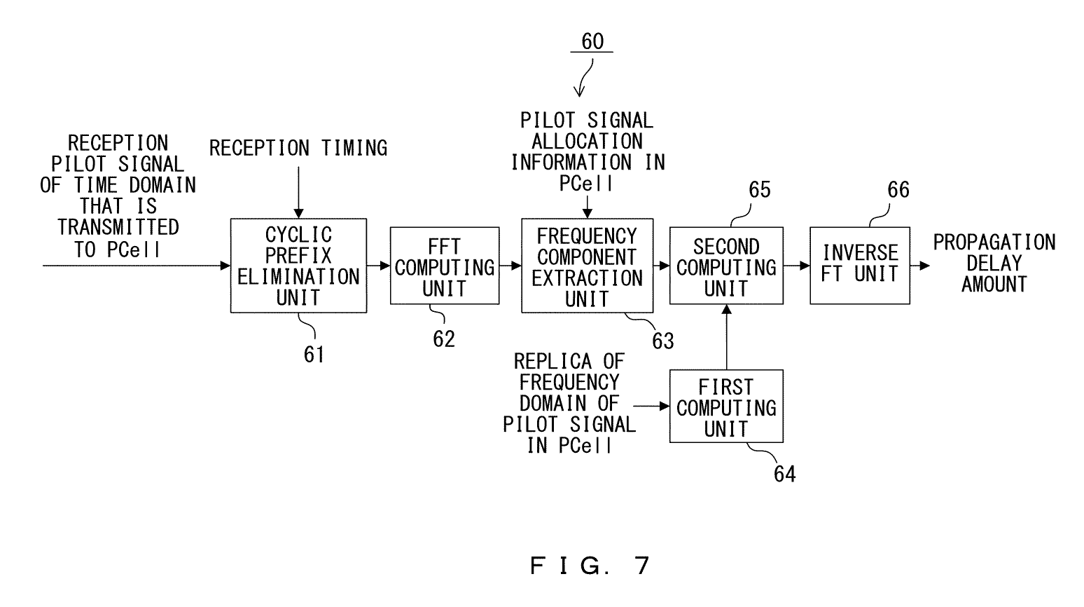

FIG. 7 is a diagram illustrating a flow of estimation of a propagation delay amount in the SCell. A propagation delay amount estimator 60 illustrated in FIG. 7 may be provided in the communication device 50 in the case in which the communication device 50 is the pico base station 22 (SCell).

As illustrated in FIG. 7, the propagation delay estimation unit 553 may include a cyclic prefix elimination unit 61, a fast Fourier transformation (FFT) computing unit 62, a frequency component extraction unit 63, a first computing unit 64, a second computing unit 65, and an inverse Fourier transformation computing unit 66. In addition, the propagation delay estimation unit 553 may include components, not illustrated, which have functions such as channel estimation and cyclic shift elimination.

The cyclic prefix elimination unit 61 eliminates a cyclic prefix from the uplink pilot signal that is transmitted to the macro base station 21 (PCell) according to the reception timing of the pico base station 22 (SCell).

The fast Fourier transformation (FFT) computing unit 62 performs Fourier transformation on the uplink pilot signal from which the cyclic prefix has been eliminated, and converts the signal into a signal of the frequency domain.

The frequency component extraction unit 63 extracts frequency components that are included in the uplink pilot signal which is transmitted to the macro base station 21 (PCell).

A replica of the frequency domain of the pilot signal in the macro base station 21 (PCell) is input to the first computing unit 64. The first computing unit 64 takes a complex conjugate of the input signal.

The second computing unit 65 computes the product of the signal that is obtained by extracting the frequency components from the pilot signal that has been output from the frequency component extraction unit 63 and the signal that has been output from the first computing unit 64.

The inverse Fourier transformation computing unit 66 performs inverse Fourier transformation on an output signal from the second computing unit 65 and converts phase information into time information. The second computing unit 65 outputs a propagation delay amount.

For example, in a case in which the communication device 50 is the macro base station 21 (PCell), the downlink transmission unit (DL transmission unit) 551 transmits simultaneously with activation of the pico base station 22 (SCell) the propagation delay amount that is estimated by the propagation delay estimation unit 553 in the pico base station 22 (SCell) to a terminal such as the user equipment 23 (UE#A) and the user equipment 24 (UE#B).

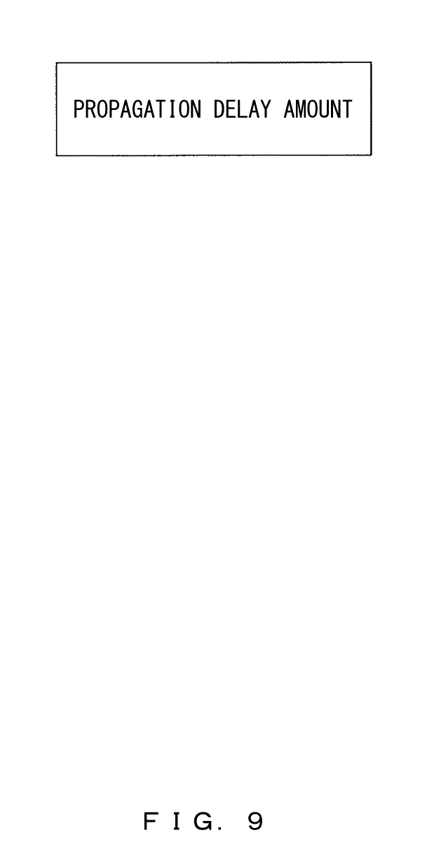

FIG. 9 is a diagram illustrating an example of a format that is used for notification of a propagation delay amount.

The format illustrated in FIG. 9 is similar to Timing Advance Command in TS36.321 V10.5. 0 6.1.5 MAC PDU (Random Access Response). However, the format that is used for notification of a propagation delay amount is not limited to the format illustrated in FIG. 9, and another format may be used as long as it contains the propagation delay amount.

In the case of Long Term Evolution (LTE), assuming that an interval of sampling time Ts in the time domain is 1Ts=0.033 microseconds, uplink timing control is performed at the resolution of a timing advance (Ta) amount. For example, 1Ta=16Ts=0.52 microseconds is possible. A propagation delay amount may be specified as an integral multiple of 1Ta=0.52 microseconds.

The baseband processing unit 54 includes a scheduler unit 541. The baseband processing unit 54 manages control of layer 1 and layer 2. The scheduler unit 541 controls schedules between users with respect to transmission and reception of a signal that is performed by the transmission and reception processing unit 55.

The high-layer processing unit 53 includes an application unit 531. Furthermore, in the case in which the communication device 50 is the macro base station 21 (PCell), the application unit 531 includes a synchronous terminal detection unit 532. The high-layer processing unit 53 performs high-layer processes such as a layer-2 process, radio resource management, and an inter-base-station signal transmission and reception process. The application unit 531 performs processing of an application. Prior to activation of the pico base station 22 (SCell), the synchronous terminal detection unit 532 generates a list of terminals that exist in the vicinity of the pico base station 22 (SCell) and are uplink-synchronized with the macro base station 21 (PCell).

The network-side interface (NW side IF) 52 performs high-layer processes such as signal transmission and reception between itself and an NW side device.

As described, the carrier aggregation system is a radio communication system in which the macro base station 21 to which the primary cell, which is an activated cell, is allocated and the pico base station 22 to which the secondary cell, which is either an activated cell or a deactivated cell, is allocated, allocate a primary cell or a secondary cell to each of a plurality of pieces of user equipment, and the macro base station 21 or the pico base station 22 communicates with each piece of the user equipment via the primary cell or the secondary cell.

The communication device that configures the pico base station 22 to which the secondary cell is allocated includes the propagation delay amount estimation unit 553 and the downlink transmission unit 551.

The propagation delay amount estimation unit 553 of the pico base station 22 receives from the macro base station 21 a terminal list, which is a list of pieces of user equipment that exist within a coverage area range of the pico base station 22 and to which a cell that is uplink-synchronized with the primary cell is allocated, and information of an uplink pilot signal in the primary cell. With respect to one of the plurality of pieces of user equipment, the propagation delay amount estimation unit 553 sniffs the uplink pilot signal that is transmitted to the macro base station 21. According to the uplink pilot signal in the primary cell and a reception timing that the pico base station 22 itself retains, the propagation delay amount estimation unit 553 estimates a propagation delay amount between the primary cell and the secondary cell and an uplink-timing correction amount, which is a correction amount of a transmission timing to be corrected in order to make the plurality of pieces of user equipment synchronous with the second base station.

The network-side interface (NW side IF) 52 of the pico base station 22 transmits to the macro base station 21 the propagation delay amount and the uplink-timing correction amount that have been estimated by the propagation delay amount estimation unit 553. The macro base station 21 that has received the propagation delay amount and the uplink-timing correction amount transmits the uplink-timing correction amount to the user equipment.

In addition, the macro base station 21 includes the synchronous terminal detection unit 532 and the transmission and reception processing unit 55.

The synchronous terminal detection unit 532 of the macro base station 21 transmits to the pico base station 22 information of the uplink pilot signal in the primary cell, detects one of the plurality of pieces of user equipment which exists within the coverage area of the pico base station 22 and to which a cell that is uplink-synchronized with the primary cell is allocated, and generates a terminal list, which is a list of pieces of user equipment.

The propagation delay estimation unit 553 of the pico base station 22 sniffs the uplink pilot signal that is transmitted from the one of the plurality of pieces of user equipment that is included in the terminal list, the transmission and reception processing unit 55 of the macro base station 21 receives a propagation delay amount between the primary cell and the secondary cell that is estimated from the uplink pilot signal in the macro base station 21 and the reception timing that the pico base station 22 retains, and transmits to the one of the plurality of pieces of user equipment an uplink-timing correction amount and information which indicates that the secondary cell which is allocated to the pico base station 22 has been activated.

As described, in the communication device 50 illustrated in FIG. 6, the synchronous terminal detection unit 532 in the application unit 531 generates a list of terminals that exist in the vicinity of the pico base station 22 (SCell) and are uplink-synchronized with the macro base station 21 (PCell), and performs a process for transmitting from the macro base station 21 (PCell) to the pico base station 22 (SCell) the generated uplink-synchronized terminal list and uplink pilot signal allocation information in the macro base station 21 (PCell). Furthermore, the propagation delay estimation unit 553 in the uplink reception unit 552 in the pico base station 22 (SCell) sniffs (receives by means of interception) the uplink pilot signal that is transmitted to the macro base station 21 (PCell) with respect to a terminal on the uplink-synchronized terminal list that has been received from the macro base station 21 (PCell), estimates propagation delay between the macro base station 21 (PCell). Then, the propagation delay estimation unit 553 performs a process for returning the propagation delay estimation result to the macro base station 21 (PCell). Furthermore, the macro base station 21 (PCell) receives a propagation delay amount between the primary cell and the secondary cell that is estimated from the uplink pilot signal in the primary cell and the reception timing that the pico base station 22 (SCell) retains, and transmits to the user equipment an uplink-timing correction amount by which the user equipment corrects the uplink timing so that the user equipment is synchronous with the pico base station 22 (SCell) and information which indicates that the secondary cell which is allocated to the pico base station 22 (SCell) has been activated.

By adopting the above-described configuration, a transmission timing of the user equipment is corrected so that a difference in uplink reception timing between the user equipment UE#A and UE#B is not generated at the reception point of the SCell after the configured state of the pico base station 22 (SCell) is changed to the activated state. Therefore, it is possible to suppress generation of uplink intersymbol interference from the user equipment UE#A and UE#B and to improve uplink throughput.

In FIG. 6, the communication device 50 may be configured as a general-purpose computer 200.

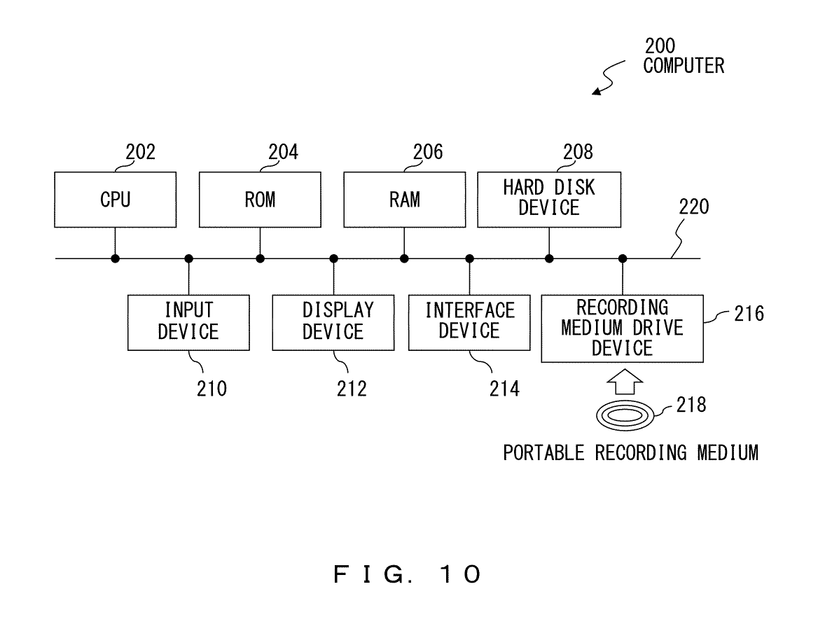

FIG. 10 is a diagram illustrating an example of a hardware configuration of the communication device 50.

The computer 200 includes a central processing unit (CPU) 202, a read only memory (ROM) 204, a random access memory (RAM) 206, a hard disk device 208, an input device 210, a display device 212, an interface device 214, and a recording medium driving device 216. Note that these constituents are interconnected via a bus line 220 and may transfer various data among them under control of the CPU 202.

The CPU 202 is an arithmetic processing device that controls the entire operation of the computer 200 and functions as a control processing unit of the computer 200.

The ROM 204 is a read-only semiconductor memory in which a specified basic control program is recorded in advance. The CPU 202 is allowed to control operation of each constituent of the computer 200 by reading and executing the basic control program at start-up of the computer 200.

The RAM 206 is a random access semiconductor memory that is used as a working storage area as appropriate when the CPU 202 executes various control programs.

The hard disk device 208 is a storage device that stores various control programs that are executed by the CPU 202 and various data. The CPU 202 is allowed to perform various control processes that will be described later by reading and executing the specified control program that is stored in the hard disk device 208.

The input device 210 is, for example, a mouse device or a keyboard device. When operated by a user of an information processing device, the input device 210 acquires input of various information that is associated with the operation content and transmits the acquired input information to the CPU 202.

The display device 212 is, for example, a liquid crystal display, and displays various texts and images according display data that is transmitted from the CPU 202.

The interface device 214 manages transfer of various information between itself and various equipment that is connected to the computer 200.

The recording medium drive device 216 is a device for reading various control programs and data that are recorded in a portable recording medium 218. The CPU 202 may perform various control processes that will be described later by reading via the recording medium drive device 216 a specified control program that is recorded in the portable recording medium 218 and executing the program. Note that examples of the portable recording medium 218 include a flash memory that is provided with a USB (universal serial bus) connector, a CD-ROM (compact disc read only memory), and a DVD-ROM (digital versatile disc read only memory).

In order to cause the computer 200 to perform a process for uplink-timing synchronization of the secondary cell, for example, a control program is generated for causing the CPU 202 to perform the control process that will be described later. The generated control program is stored in advance in the hard disk device 208 or the portable recording medium 220. Then, a specified instruction is given to the CPU 202 so that the CPU 202 is caused to read and execute the control program. Thus, the computer 200 is allowed to perform the process for uplink-timing synchronization of the secondary cell.

### <Communication Method>

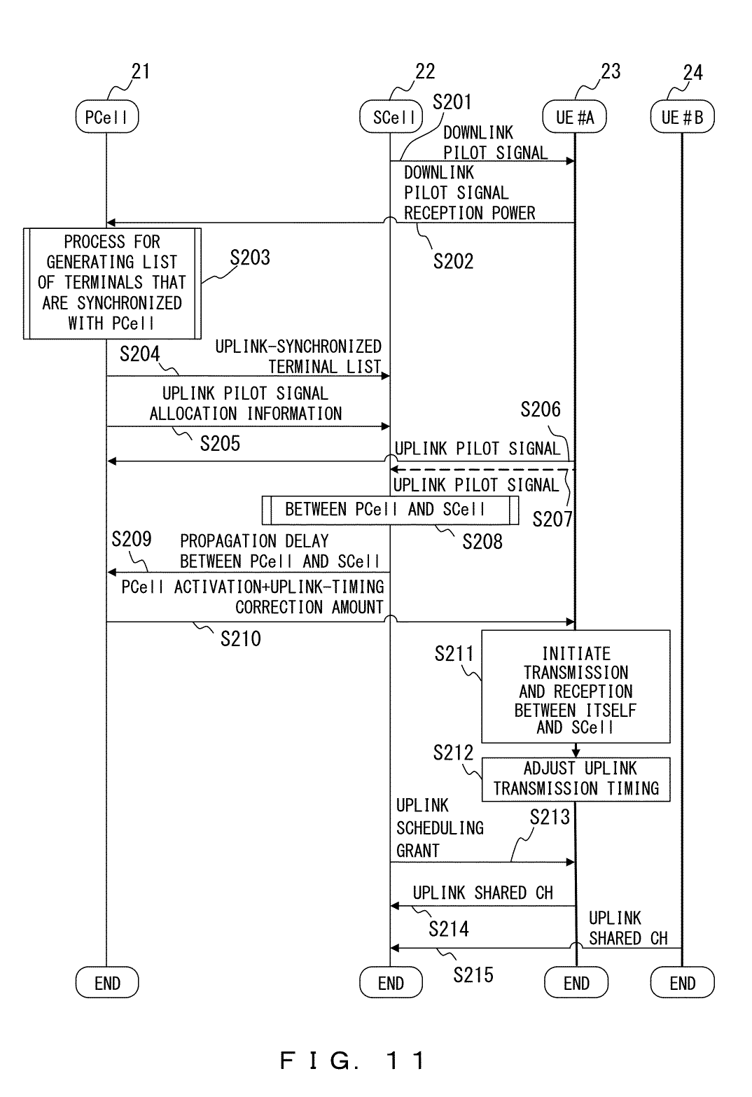

FIG. 11 is a diagram illustrating a flow of an uplink-timing synchronization process of the SCell in the example.

In addition, in a case in which the communication device is the general-purpose computer 200 illustrated in FIG. 10, the following description defines a control program that performs such a process. That is, the following is the description of the control program for causing the general-purpose computer to execute the process that will be described in the following.

FIG. 11 illustrates a flow of the process that is performed when the SCell is activated in the carrier aggregation system 20 which includes the macro base station 21 (PCell), the pico base station 22 (SCell), the user equipment 23 (UE#A), and the user equipment 24 (UE#B). Before the process is initiated, the configured state of the pico base station 22 (SCell) is the deactivated state. Hereinafter, the user equipment may be referred to as a terminal. In addition, it is assumed that the user equipment 23 (UE#A) is uplink-synchronized with the macro base station 21 (PCell). Furthermore, it is assumed that the user equipment 24 (UE#B) is uplink-synchronized with the pico base station 22 (SCell).

In S201, the user equipment 23 (UE#A) receives a downlink pilot signal from the macro base station 21 (PCell) in S201. For example, the user equipment 23 (UE#A) measures downlink pilot signal reception power.

In S202, the user equipment 23 (UE#A) notifies the macro base station 21 (PCell) of the downlink pilot signal reception power.

In S203, the macro base station 21 (PCell) performs a process for generating a list of terminals that are synchronized with the macro base station itself.

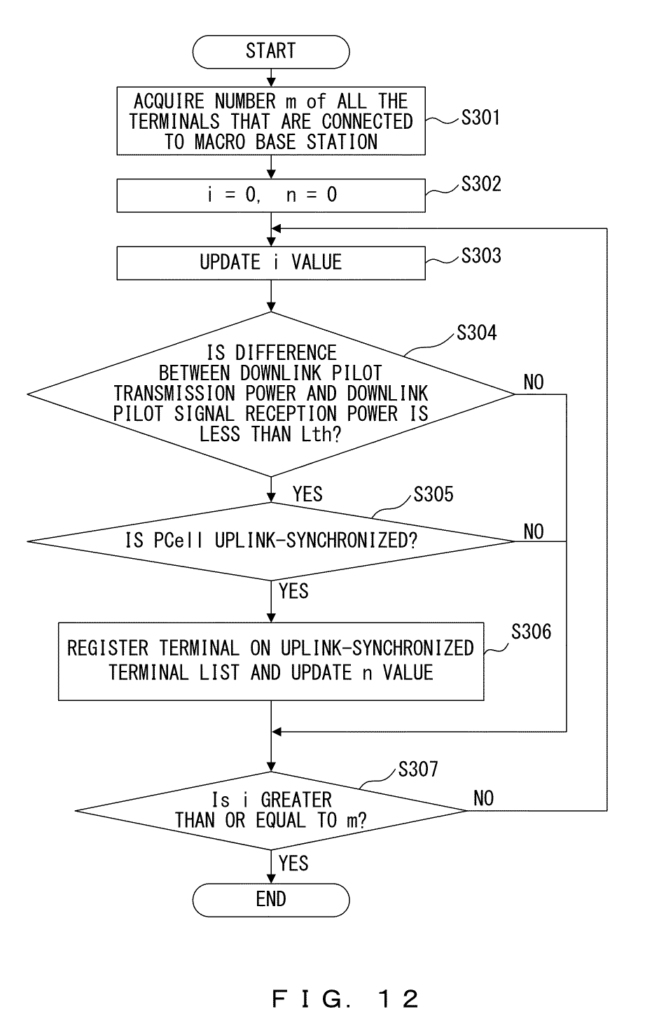

The terminal list generation process that is performed by the macro base station 21 (PCell) in S203 will be described with reference to FIG. 12. This process may be performed by the synchronous terminal detection unit 532 of the application unit 531 of the communication device 50.

When the process is initiated, in S301, the synchronous terminal detection unit 532 of the application unit 531 of the macro base station 21 (PCell) acquires the number m of all the terminals that are connected to the macro base station 21 (PCell).

In S302, the synchronous terminal detection unit 532 resets a dummy variable i that represents an integer which indexes a terminal. That is, i=0. Furthermore, the synchronous terminal detection unit 532 resets the number n of pieces of user equipment that exist in the vicinity of the pico base station 22 (SCell) and are uplink-synchronized with the macro base station 21 (PCell). That is, n=0.

In S303, the synchronous terminal detection unit 532 of the macro base station 21 (PCell) increments the value of the dummy variable i by one.

In S304, the synchronous terminal detection unit 532 of the macro base station 21 (PCell) judges whether or not the difference between downlink pilot transmission power and the downlink pilot signal reception power is less than a threshold Lth. In a case in which the judgement is “Yes”, that is, the difference between the downlink pilot transmission power and the downlink pilot signal reception power is less than the threshold Lth, the process proceeds to S305. In addition, in a case in which the judgment is “No”, that is, the difference between the downlink pilot transmission power and the downlink pilot signal reception power is not less than the threshold Lth, the process proceeds to S307.

In S305, the synchronous terminal detection unit 532 of the macro base station 21 (PCell) judges whether or not the terminal that is specified by the index i is uplink-synchronized with the macro base station 21 (PCell). In a case in which the judgement is “Yes”, that is, the terminal that is specified by the index i is uplink-synchronized with the macro base station 21 (PCell), the process proceeds to S306. In addition, in a case in which the judgement is “No”, that is, the terminal that is specified by the index i is not uplink-synchronized with the macro base station 21 (PCell), the process proceeds to S307.

In S306, the synchronous terminal detection unit 532 of the macro base station 21 (PCell) registers the terminal that is specified by the index i on the uplink-synchronized terminal list and increments by one the value of the number n (n value) of pieces of user equipment that exist in the vicinity of the pico base station 22 (SCell) and are uplink-synchronized with the macro base station 21 (PCell).

In S307, the synchronous terminal detection unit 532 of the macro base station 21 (PCell) judges whether or not the value of the index i is greater than or equal to the number m of all the terminals that are connected to the macro base station 21 (PCell). In a case in which the judgement is “Yes”, that is, the value of the index i (i value) is greater than or equal to the number m of all the terminals that are connected to the macro base station 21 (PCell), the process is terminated. In addition, in a case in which the judgement is “No”, that is, the value of the index i (i value) is less than the number m of all the terminals that are connected to the macro base station 21 (PCell), the process returns to S303.

Returning to FIG. 11, in S204, the synchronous terminal detection unit 532 of the macro base station 21 (PCell) notifies the pico base station 22 (SCell) of the uplink-synchronized terminal list that has been generated in S203.

In S205, the macro base station 21 (PCell) notifies the pico base station 22 (SCell) of uplink pilot signal allocation information.

In S206, the user equipment 23 (UE#A) notifies the macro base station 21 (PCell) of uplink pilot signal.

In S207, the pico base station 22 (SCell) sniffs (receives by means of interception) an uplink pilot signal that is transmitted to the macro base station 21 (PCell) with respect to a terminal on the uplink-synchronized terminal list.

In S208, the pico base station 22 (SCell) performs an estimation process of the propagation delay amount between the macro base station 21 (PCell) and the pico base station 22 (SCell).

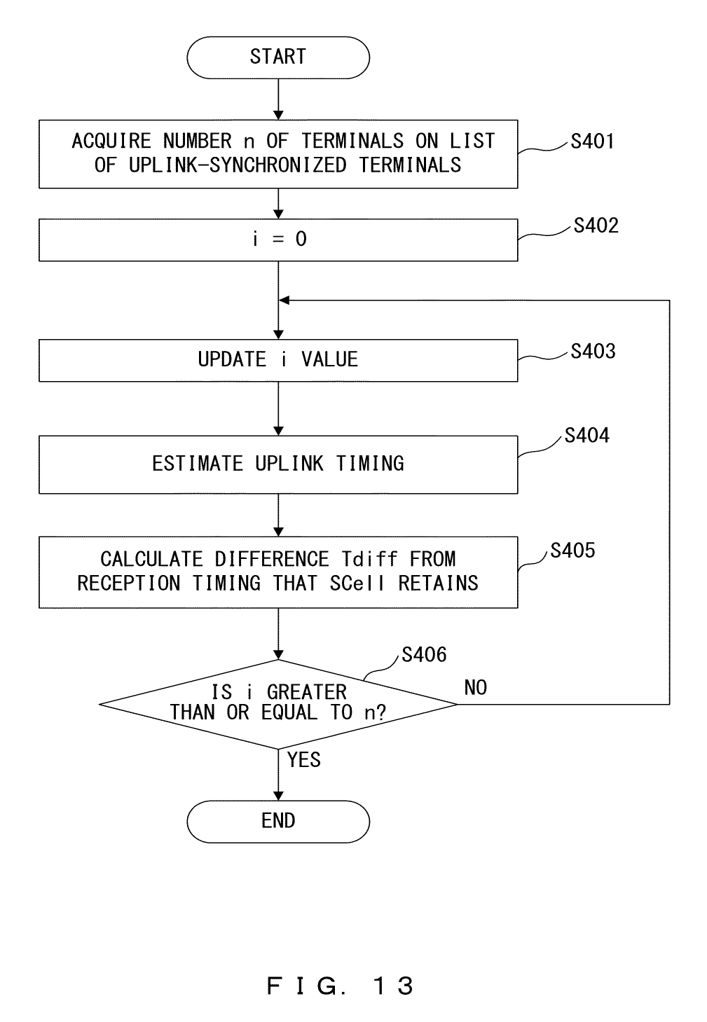

The estimation process of the propagation delay amount between the macro base station 21 (PCell) and the pico base station (SCell) will be described with reference to FIG. 13.

When the process is initiated, in S401, the propagation delay estimation unit 553 of the pico base station 22 (SCell) acquires the number n of terminals on the list of uplink-synchronized terminals, that is, the number n of terminals that are included in the uplink-synchronized terminal list.

In S402, the propagation delay estimation unit 553 of the pico base station 22 (SCell) resets a dummy variable i that represents an integer which indexes a terminal. That is, i=0.

In S403, the propagation delay estimation unit 553 of the pico base station 22 (SCell) updates the value of the dummy variable i. For example, the propagation delay estimation unit 553 of the pico base station 22 (SCell) increments the value of the dummy variable i by one.

In S404, the propagation delay estimation unit 553 of the pico base station 22 (SCell) estimates a propagation delay amount between the macro base station 21 (PCell) and the pico base station 22 (SCell). At that time, the propagation delay estimation unit 553 of the pico base station 22 (SCell) may estimate the propagation delay amount according to the method illustrated in FIG. 7.

In S405, the propagation delay estimation unit 553 of the pico base station 22 (SCell) calculates a timing difference Tdiff, which is a difference between the reception timing that the propagation delay estimation unit 553 itself retains and the reception timing that the macro base station 21 (PCell) retains, according to the propagation delay amount.

In S406, the propagation delay estimation unit 553 of the pico base station 22 (SCell) judges whether or not the value of the index i is greater than or equal to the number n of terminals on the uplink-synchronized terminal list. In a case in which the judgement is “Yes”, that is, the value of the index i (i value) is greater than or equal to the number n of terminals on the uplink-synchronized terminal list, the process is terminated. In addition, in a case in which the judgement is “No”, that is, the value of the index i (i value) is less than the number n of terminals on the uplink-synchronized terminal list, the process returns to S403.

Returning to FIG. 11, in S209, the pico base station 22 (SCell) notifies the macro base station 21 (PCell) of the propagation delay amount between the macro base station 21 (PCell) and the pico base station 22 (SCell).

In S210, the macro base station 21 (PCell) notifies the user equipment 23 (UE#A) of activation of the pico base station 22 (SCell). In addition, in S210, the macro base station 21 (PCell) notifies the user equipment 23 (UE#A) of an uplink-timing correction amount Tdiff.

In S211, the user equipment 23 (UE#A) initiates transmission and reception between itself and the pico base station 22 (SCell).

In S212, the user equipment 23 (UE#A) adjusts an uplink transmission timing by using the uplink-timing correction amount Tdiff.

In S213, the pico base station 22 (SCell) gives to the user equipment 23 (UE#A) a notification for uplink scheduling grant.

In S214, the user equipment 23 (UE#A) notifies the pico base station 22 (SCell) of an uplink shared channel (CH).

Almost simultaneously with S214, in S215, the user equipment 24 (UE#B) notifies the pico base station 22 (SCell) of the uplink shared channel (CH).

As described, the communication method that is processed by the communication device which configures the pico base station 22 includes: receiving from the macro base station 21 a terminal list, which is a list of pieces of user equipment that exist within a coverage area range of the pico base station 22 and to which a cell that is uplink-synchronized with the primary cell is allocated, and information of an uplink pilot signal in the primary cell; sniffing the uplink pilot signal that is transmitted to the macro base station 21, with respect to one of the plurality of pieces of user equipment that is included in the terminal list; estimating a propagation delay amount between the primary cell and the secondary cell and an uplink-timing correction amount from the uplink pilot signal in the macro base station 21 and a reception timing that the pico base station 22 itself retains; and transmitting to the first base station the estimated propagation delay amount and the uplink-timing correction amount.

In addition, the communication method that is processed by the communication device which configures the macro base station 21 includes: transmitting to the pico base station 22 information of the uplink pilot signal in the primary cell; detecting one of the plurality of pieces of user equipment that exists within the coverage area of the pico base station 22 to which the secondary cell is allocated and to which user equipment a cell that is uplink-synchronized with the primary cell is allocated; generating a terminal list, which is a list of the pieces of user equipment; sniffing the uplink pilot signal that is transmitted from the one of the plurality of pieces of user equipment which is included in the terminal list; receiving a propagation delay amount between the primary cell and the secondary cell that is estimated from the uplink pilot signal in the primary cell and a reception timing that the pico base station 22 retains; and transmitting to the one of the plurality of pieces of user equipment an uplink-timing correction amount and information which indicates that the secondary cell which is allocated to the pico base station 22 has been activated.

By performing the above process, a transmission timing of the user equipment is corrected so that a difference in uplink reception timing between the user equipment UE#A and UE#B is not generated at the reception point of the secondary cell (SCell) after the configured state of the SCell is changed to the activated state. Therefore, it is possible to suppress generation of uplink intersymbol interference from the user equipment UE#A and UE#B and to improve uplink throughput.

The transmission timing of the user equipment is corrected so that a difference in uplink reception timing between the user equipment UE#A and UE#B is not generated at the reception point of the secondary cell (SCell) after the configured state of the SCell is changed to the activated state. Therefore, it is possible to suppress generation of uplink intersymbol interference from the user equipment UE#A and UE#B and to improve uplink throughput.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device that configures a second base station in a radio communication system in which a first base station to which a primary cell, which is an activated cell, is allocated and the second base station to which a secondary cell, which is either an activated cell or an deactivated cell, is allocated, allocate the primary cell or the secondary cell to each of a plurality of pieces of user equipment, and the first base station or the second base station communicates with each piece of the user equipment via the primary cell or the secondary cell, the communication device comprising:
a propagation delay amount estimation unit that receives from the first base station a terminal list, which is a list of pieces of user equipment that exist within a coverage area range of the second base station and to which a cell that is uplink-synchronized with the primary cell is allocated, and information of an uplink pilot signal in the primary cell, sniffs the uplink pilot signal that is transmitted to the first base station with respect to one of the plurality of pieces of user equipment which is included in the terminal list, and estimates a propagation delay amount between the primary cell and the secondary cell and an uplink-timing correction amount, which is a correction amount of a transmission timing to be corrected in order to make the plurality of pieces of user equipment synchronous with the second base station according to the uplink pilot signal in the primary cell and a reception timing that the communication device retains; and
a network-side interface that transmits to the first base station the propagation delay amount that is estimated by the propagation delay amount estimation unit and the uplink-timing correction amount.

2. The communication device according to claim 1, wherein
the propagation delay amount estimation unit estimates a propagation delay amount between the one of the pieces of user equipment and the first base station according to uplink pilot signal allocation setting information in the primary cell that is allocated to the first base station, and estimates according to the propagation delay amount a timing difference, which is a difference between a reception timing that the first base station retains and a reception timing that the second base station retains.

3. A communication device that configures a first base station in a radio communication system in which the first base station to which a primary cell, which is an activated cell, is allocated and a second base station to which a secondary cell, which is either an activated cell or an deactivated cell, is allocated, allocate the primary cell or the secondary cell to each of a plurality of pieces of user equipment, and the first base station or the second base station communicates with each piece of the user equipment via the primary cell or the secondary cell, the communication device comprising:
a synchronous terminal detection unit that transmits to the second base station information of an uplink pilot signal in the primary cell, detects one of the plurality of pieces of user equipment that exists within a coverage area range of the second base station and to which a cell that is uplink-synchronized with the primary cell is allocated, and generates a terminal list, which is a list of the pieces of user equipment; and
a transmission and reception processing unit that sniffs the uplink pilot signal that is transmitted from the one of the plurality of pieces of user equipment that is included in the terminal list, receives a propagation delay amount between the primary cell and the secondary cell that is estimated from the uplink pilot signal in the primary cell and a reception timing that the second base station retains, and transmits to the one of the plurality of pieces of user equipment an uplink-timing correction amount and information which indicates that the secondary cell that is allocated to the second base station has been activated.

4. A communication method that is processed by a communication device which configures a second base station in a radio communication system in which a first base station to which a primary cell, which is an activated cell, is allocated and the second base station to which a secondary cell, which is either an activated cell or a deactivated cell, is allocated, allocate the primary cell or the secondary cell to each of a plurality of pieces of user equipment, and the first base station or the second base station communicates with each piece of the user equipment via the primary cell or the secondary cell, the communication method comprising:
receiving from the first base station a terminal list, which is a list of pieces of user equipment that exist within a coverage area range of the second base station and to which a cell that is uplink-synchronized with the primary cell is allocated, and information of an uplink pilot signal in the primary cell;
sniffing the uplink pilot signal that is transmitted to the first base station with respect to one of the plurality of pieces of user equipment that is included in the terminal list;
estimating a propagation delay amount between the primary cell and the secondary cell and an uplink-timing correction amount, which is a correction amount of a transmission timing to be corrected in order to make the plurality of pieces of user equipment synchronous with the second base station, according to the uplink pilot signal in the first base station and a reception timing that the communication device itself retains; and
transmitting to the first base station the estimated propagation delay amount and uplink-timing correction amount.

5. The communication method according to claim 4, further comprising:
estimating a propagation delay amount between each piece of the user equipment and the first base station according to uplink pilot signal allocation setting information in the primary cell that is allocated to the first base station; and estimating according to the propagation delay amount a timing difference, which is a difference between a reception timing that the first base station retains and a reception timing that the second base station retains.

6. A communication method that is processed by a communication device which configures a first base station in a radio communication system in which the first base station to which a primary cell, which is an activated cell, is allocated and a second base station to which a secondary cell, which is either an activated cell or an deactivated cell, is allocated, allocate the primary cell or the secondary cell to each of a plurality of pieces of user equipment, and the first base station or the second base station communicates with each piece of the user equipment via the primary cell or the secondary cell, the communication method comprising:
transmitting to the second base station information of an uplink pilot signal in the primary cell and detecting one of the plurality of pieces of user equipment that exists within a coverage area range of the second base station to which a cell that is uplink-synchronized with the primary cell is allocated;
generating a terminal list, which is a list of the pieces of user equipment; and
sniffing the uplink pilot signal that is transmitted from the one of the plurality of pieces of user equipment that is included in the terminal list;
receiving a propagation delay amount between the primary cell and the secondary cell that is estimated from the uplink pilot signal in the primary cell and a reception timing that the second base station retains; and
transmitting to the one of the plurality of pieces of user equipment an uplink-timing correction amount and information which indicates that the secondary cell which is allocated to the second base station has been activated.
